(19) United States
(12) Patent Application Publication
(10) Pub. No.: US 2008/0248456 A1
(43) Pub. Date: Oct. 9, 2008

(54) Reorientable Dry Erase Board

(76) Inventors: Albert B. Cheris, Winnetka, IL (US); Paul A. Moniuszko, Bartlett, IL (US); Glenn Thomas Walters, Port Washington, WI (US)

Correspondence Address: NEAL, GERBER, & EISENBERG, SUITE 2200, 2 NORTH LASALLE STREET, CHICAGO, IL, 60602, US

(21) Appl. No.: 12/062,009

(22) Filed: Apr. 3, 2008

Related U.S. Application Data
(60) Provisional application No. 60/910,756, filed on Apr. 9, 2007.

(51) Int. Cl. B43L 1/00

(52) U.S. Cl. 434/415; 434/421

(57) ABSTRACT

This invention relates generally to boards for writing or display, and more particularly to reusable, double sided, reorientable, portable and reconfigurable boards that permit writing to be easily removed. In one embodiment, a writing board comprises a frame, a front panel and a rear panel mounted in the frame, wherein the front panel comprises a first writing surface and the rear panel comprises a second writing surface opposite the first writing surface, wherein the first writing surface and the second writing surface are each adapted to erasably receive writing thereon. The writing board is reorientable to receive erasable writing on the first writing surface and the second writing surface.

### CROSS-REFERENCE TO RELATED APPLICATIONS

This application claims priority to U.S. Provisional Patent Application Ser. No. 60/910,756 filed on Apr. 9, 2007, which is incorporated herein by reference in its entirety.

### BACKGROUND OF THE INVENTION

This invention relates generally to boards for writing or display, and more particularly to reusable, double sided, reorientable, portable and reconfigurable boards that permit writing to be easily removed.

### SUMMARY OF THE INVENTION

In one embodiment of the invention a writing board comprises a frame, a front panel and a rear panel mounted in the frame, wherein the front panel comprises a first writing surface and the rear panel comprises a second writing surface opposite the first writing surface, wherein the first writing surface and the second writing surface are each adapted to erasably receive writing thereon. The writing board is reorientable to receive writing on the first writing surface and the second writing surface. At least one of the front panel and the rear panel may comprise a magnetic property.

The writing board may include a wall mount for hanging the writing board on a wall. In one embodiment, the wall mount may comprise a mount ring releasably affixed to the wall and a hanger releasably affixed to the mount ring. The hanger comprises a protrusion extending away from the mount ring. In another embodiment, the wall mount may comprise a hanger releasably affixed to the wall. In this embodiment, the hanger comprises a protrusion extending away from the wall. The writing board further comprises a receiver mounted in the frame and forming a passage through the writing board for receiving the protrusion of the hanger.

A writing utensil holder may be integrally formed with the frame for releasably securing a writing utensil to the writing board. The receiver may form a bottom surface of the writing utensil holder and may include a non-slip surface for mating with the writing utensil and for mating with the protrusion of the hanger.

The frame of the writing board may comprise a front frame member connected to a rear frame member, wherein the front panel may be mounted to the front frame member and the rear panel is mounted to the rear frame member. The frame may include a plurality of nubs mounted in the frame and protruding therefrom to minimize movement, rocking or rattling of the writing board during use.

The writing board of this embodiment may also include a plurality of legs, which may be extendable from and retractable into the frame. The plurality of legs may be rotatable over a range exceeding 180° and/or positionable to tilt the writing board to at least one predetermined angle. Each of the plurality of legs may include at least one keeper for releasably holding the legs in any one of a number of predetermined angles or to releasably secure the legs within the frame. In addition, each of the plurality of legs may include an end cap to minimize movement, rocking or rattling of the writing board during use.

In another embodiment, a writing board comprises at least one writing panel mounted to a frame where the writing panel is adapted to erasably receive writing thereon, a writing utensil holder integrally formed with the frame for releasably securing a writing utensil to the writing board, and a plurality of legs extendable from and retractable into the frame, the plurality of legs positionable to tilt the writing board to at least one predetermined angle.

The writing board may be reorientable to receive writing on a first and a second side of the at least one writing panel. The writing board may further include a film adapted to erasably receive writing thereon, the film being affixed to at least one of the first and second sides of the at least one writing panel. The at least one writing panel may comprise a magnetic property.

The writing board may include a wall mount for hanging the writing board on a wall. In one embodiment, the wall mount may comprise a mount ring releasably affixed to the wall and a hanger releasably affixed to the mount ring. The hanger comprises a protrusion extending away from the mount ring. In another embodiment, the wall mount may comprise a hanger releasably affixed to the wall. In this embodiment, the hanger comprises a protrusion extending away from the wall. The writing board further comprises a receiver mounted in the frame and forming a passage through the writing board for receiving the protrusion of the hanger.

The hanger may be fastened to the wall using a hook and loop fastener. The writing board may include a core comprising one of a solid, corrugated, porous, or hollow structure.

In yet another embodiment of the invention, a writing board comprises at least one writing panel mounted to a frame, where the writing panel is adapted to erasably receive writing thereon, and a receiver mounted in the frame and forming a passage through the writing board for receiving a hanger. The writing board is reorientable to receive writing on a first and a second side of the at least one writing panel.

The frame may include a writing utensil holder integrally formed with the frame for releasably securing a writing utensil to the writing board. The frame may also include a plurality of receptacles for housing a plurality of legs, wherein the plurality of legs are extendable from and retractable into the plurality of receptacles, the plurality of legs being positionable to tilt the writing board to at least one predetermined angle. The writing board may further include a hanger releasably affixed to a wall, where the hanger may comprise a protrusion having a non-slip surface for releasable mating with the receiver. The at least one writing panel may comprise a magnetic property.

A better understanding of the objects, advantages, features, properties and relationships of the invention will be obtained from the following detailed description and accompanying drawings which set forth illustrative embodiments that are indicative of the various ways in which the principles of the invention may be employed.

### BRIEF DESCRIPTION OF THE DRAWINGS

For a better understanding of the invention, reference may be had to preferred embodiments shown in the following drawings in which:

FIG. 1 illustrates a right front perspective view of one embodiment of the present invention;

FIG. 2 illustrates a front elevational view of the embodiment of FIG. 1;

FIG. 3 illustrates a right side elevational view of the embodiment of FIG. 1 showing the legs in a fully articulated position;

FIG. 4 illustrates a top front perspective view of the embodiment of FIG. 1;

FIG. 5 illustrates a top right perspective view of the embodiment of FIG. 4 showing the legs in a fully articulated position and the invention in use on a horizontal surface;

FIG. 6a illustrates a partial perspective view of the invention showing one leg in the stowed position;

FIG. 6b illustrates a partial perspective view of the embodiment of FIG. 6a showing one leg in its fully extended position;

FIG. 6c illustrates a partial perspective view of the embodiment of FIG. 6a showing one leg in a partially articulated position;

FIG. 6d illustrates a partial perspective view of the embodiment of FIG. 6a showing one leg in a fully articulated position;

FIG. 7a illustrates an exploded front perspective view of one embodiment of the invention;

FIG. 7b illustrates a front elevational view of the embodiment of FIG. 7a;

FIG. 7c illustrates a right side elevational view of the embodiment of FIG. 7a;

FIG. 8a illustrates a front perspective view of the dry erase panels shown in FIG. 7a;

FIG. 8b illustrates a front elevational view of the dry erase panels shown in FIG. 8a;

FIG. 8c illustrates a right side elevational view of the dry erase panels shown in FIG. 8a;

FIG. 9a illustrates a front perspective view of the front frame member shown in FIG. 7a;

FIG. 9b illustrates a front perspective view of the rear frame member shown in FIG. 7a;

FIG. 9c illustrates a front elevational view of the rear frame member shown in FIG. 9b;

FIG. 9d illustrates right side elevational view of the rear frame member shown in FIG. 9b;

FIG. 9e illustrates a front elevational view of the front frame member shown in FIG. 9a;

FIG. 9f illustrates a right side elevational view of the front frame member shown in FIG. 9a;

FIG. 9g illustrates a top plan view of the rear frame member shown in FIG. 9b;

FIG. 9h illustrates a top section view taken from FIG. 9d;

FIG. 9i illustrates a partial detail view taken from FIG. 9h;

FIG. 10a illustrates a front perspective view of the grommet shown in FIG. 7a;

FIG. 10b illustrates a front elevational view of the grommet shown in FIG. 10a;

FIG. 10c illustrates a right side elevational view of the grommet shown in FIG. 10a;

FIG. 10d illustrates a top section view taken of FIG. 10b;

FIG. 10e illustrates a top plan view of the grommet of FIG. 10a;

FIG. 11a illustrates a top perspective view of one leg shown in FIG. 7a;

FIG. 11b illustrates a top plan view of the leg shown in FIG. 11a;

FIG. 11c illustrates a right side elevational view of the leg shown in FIG. 11a;

FIG. 11d illustrates a left side elevational view of the leg shown in FIG. 11a;

FIG. 11e illustrates a front elevational view of the leg shown in FIG. 11a;

FIG. 12a illustrates a front perspective view of one end cap shown in FIG. 7a;

FIG. 12b illustrates a front elevational view of the end cap shown in FIG. 12a;

FIG. 12c illustrates a bottom plan view of the end cap shown in FIG. 12a;

FIG. 12d illustrates a right side elevational view of the end cap FIG. 12a;

FIG. 12e illustrates a front section view taken of FIG. 12d;

FIG. 13a illustrates a side perspective view of one nub shown in FIG. 7a;

FIG. 13b illustrates a front elevational view of the nub shown in FIG. 13a;

FIG. 13c illustrates right side elevational view of the nub shown in FIG. 13a;

FIG. 13d illustrates top plan view of the nub shown in FIG. 13a;

FIG. 14a illustrates a front perspective view of the hanger shown in FIG. 7a;

FIG. 14b illustrates a front elevational view of the hanger shown in FIG. 14a;

FIG. 14c illustrates left side section view taken of FIG. 14b;

FIG. 14d illustrates a left side elevational view of the hanger shown in FIG. 14a;

FIG. 15a illustrates a front perspective view of the mount ring shown in FIG. 7a;

FIG. 15b illustrates a front elevational view of the mount ring shown in FIG. 15a; and

FIG. 15c illustrates a right side elevational view of the mount ring shown in FIG. 15a.

### DETAILED DESCRIPTION

An understanding of the objects, advantages, features, properties and relationships of the invention will be obtained from the following detailed description and accompanying drawings which set forth illustrative embodiments that are indicative of the various ways in which the principles of the invention may be employed.

While this invention is susceptible of embodiments in many different forms, there is shown in the drawings and will herein be described in detail, a preferred embodiment of the invention with the understanding that the present disclosure should be considered as an exemplification of the principles of the invention and is not intended to limit the broad aspects of the invention to the embodiments illustrated herein.

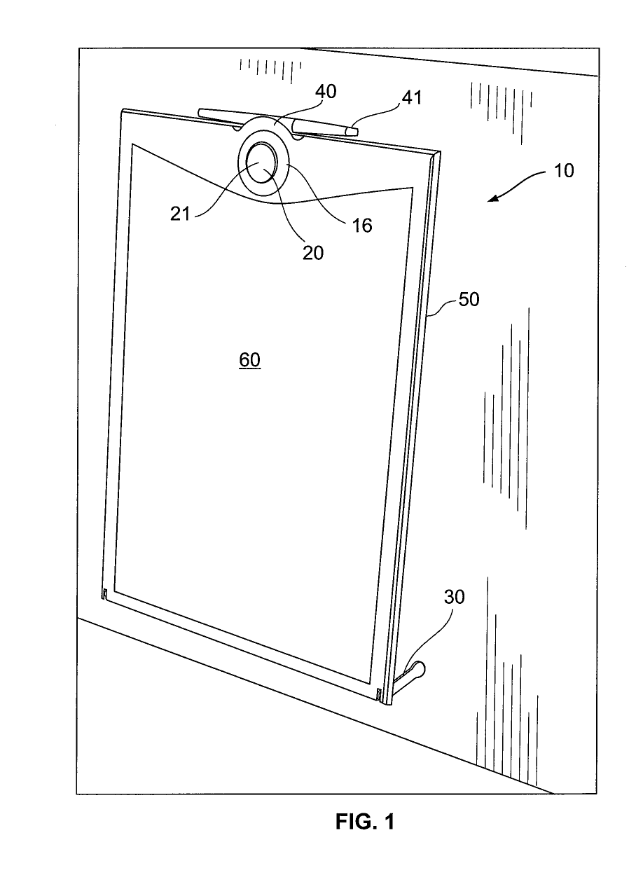

Turning now to the figures, wherein like reference numerals refer to like elements, there is illustrated in FIG. 1 reorientable dry erase writing board 10 incorporating the improvements of the present invention. As best shown in FIGS. 1-3, writing board 10 may be mounted or hung on a wall using an apparatus of the present invention. Alternatively, writing board 10 may be used on any generally flat surface or even on one's own lap, for example. Owing to its versatility, writing board 10 may include dry erase writing panel 60 on one or both the front and rear sides of writing board 10. Thus, a user may flip writing board 10 over, whether writing board 10 is mounted on a wall or not, and use the opposite side of writing board 10.

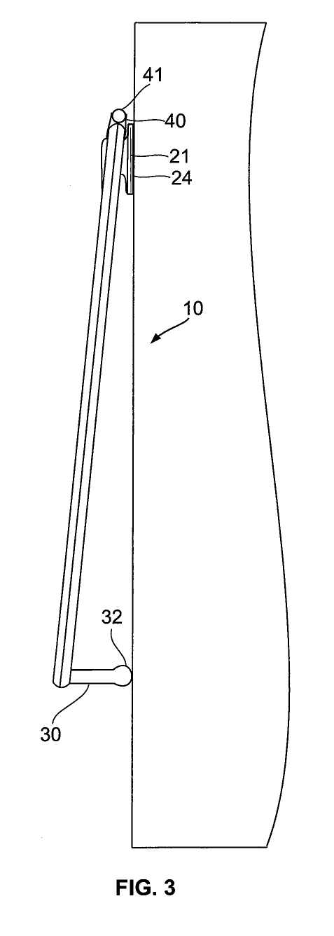

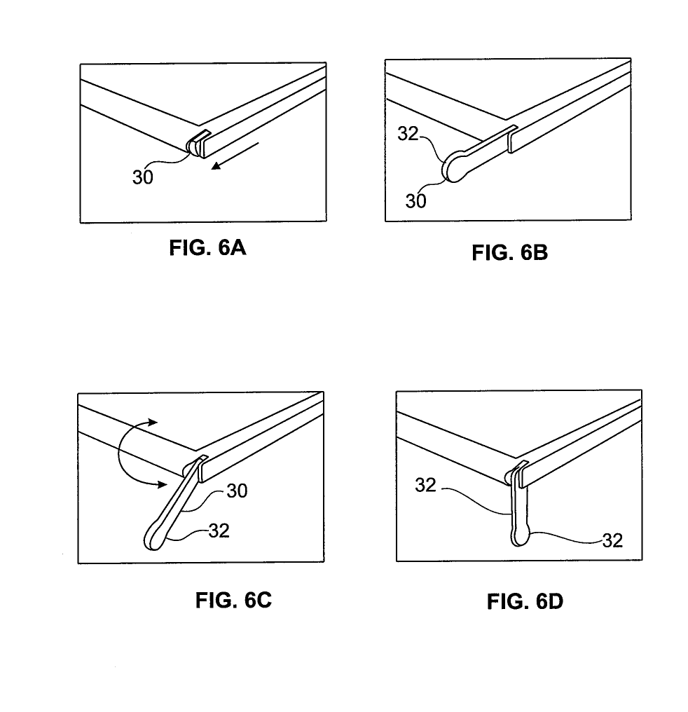

As shown in FIGS. 1-3, writing board 10 may include the following aspects: one or more dry erase writing panels 60 positioned on one or both of the front and rear sides of writing board 10, hanger 20, legs 30, and writing utensil holder 40. To ergonomically adjust writing board 10 for users, legs 30 may extend from bottom edge 14 of writing board 10 and be rotatably positionable, as best shown in FIGS. 6a-6d, to cause writing board 10 to lie at one of a plurality of a predetermined angles with respect to the wall, as shown in FIGS. 1 and 3. Legs 30 may articulate and/or rotate more than 180°, as illustrated in FIG. 6c, to permit use of the other side of writing board 10 at a predetermined angle with respect to the wall.

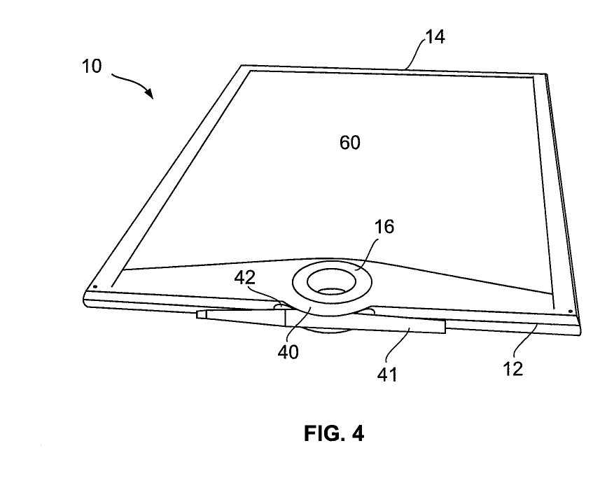

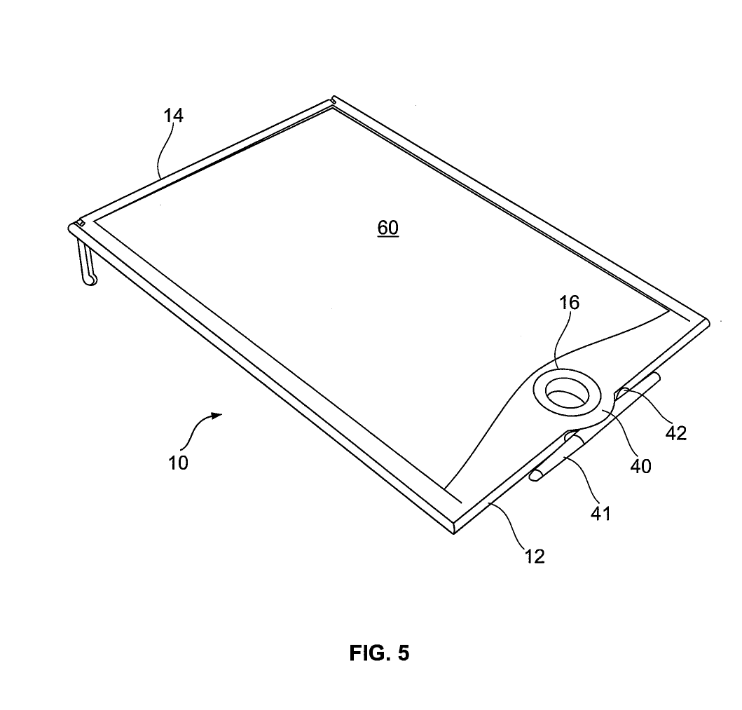

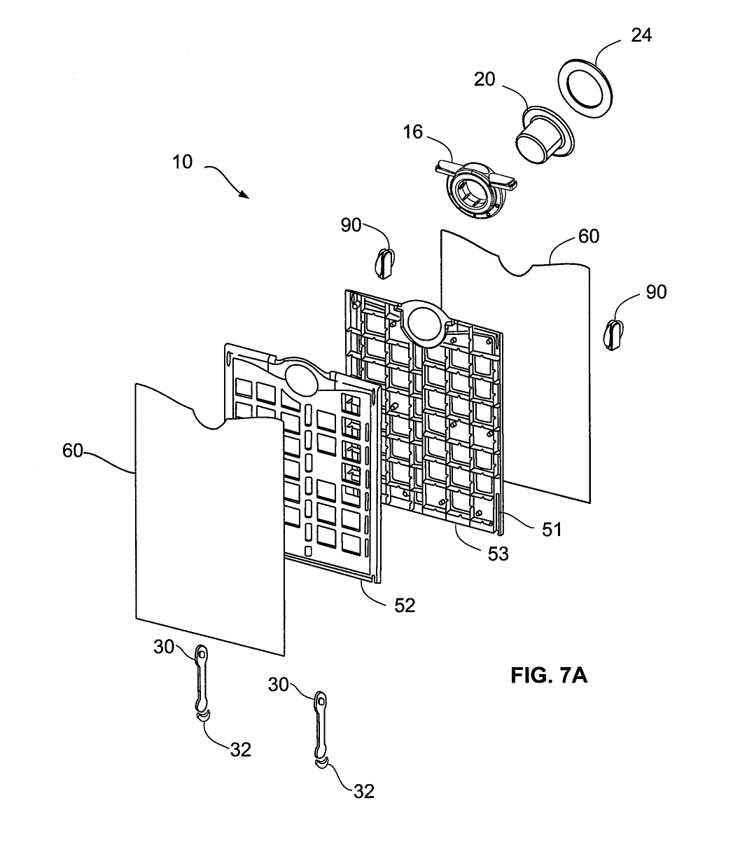

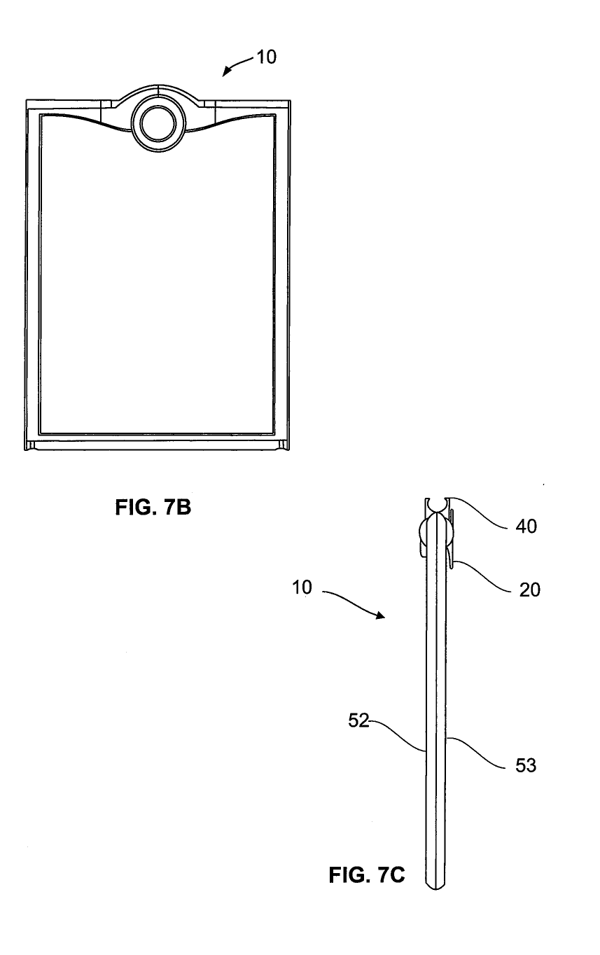

As shown in FIGS. 4-5, writing board 10 may also be portable in that it is not necessary to use writing board 10 while mounted on a wall. For example, writing board 10 may be set on a table, floor, or other generally flat, horizontal surface and oriented so that top edge 12 of writing board 10 is pointed toward the user. Legs 30 may also be extended and rotated in much the same way as described above to cause writing board 10 to lie at a predetermined angle with respect to the table, etc. Writing board 10 may be caused to lie flat on the table, etc. by rotating legs 10 to lie generally in the same plane of writing board 10, or further, by retracting legs 10 into receptacle 51 of writing board 10 (see, e.g., FIGS. 6a, and 7a) if the user does not wish to elevate bottom edge 14 of writing board 10.

To hang or mount writing board 10 on a wall, hanger 20 may be used, as shown in FIGS. 1-3 and 14a-14d. Hanger 20 includes protrusion 21 to connect with writing board 10 for mounting or hanging on a wall. Hanger 20 may be made from a plastic, such as ABS, high impact polystyrene, or polycarbonate, or a metal, such as aluminum, for example.

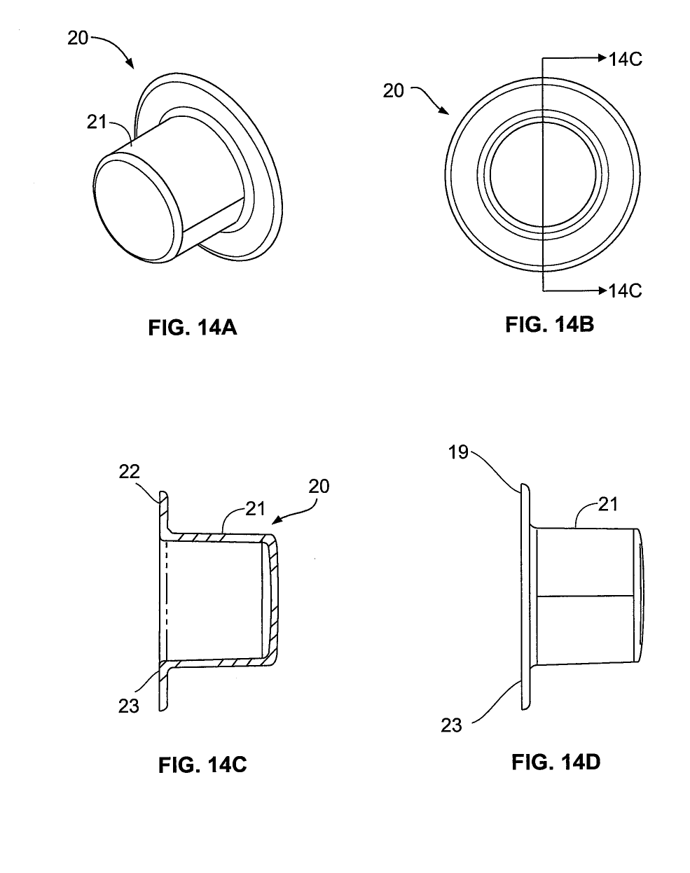

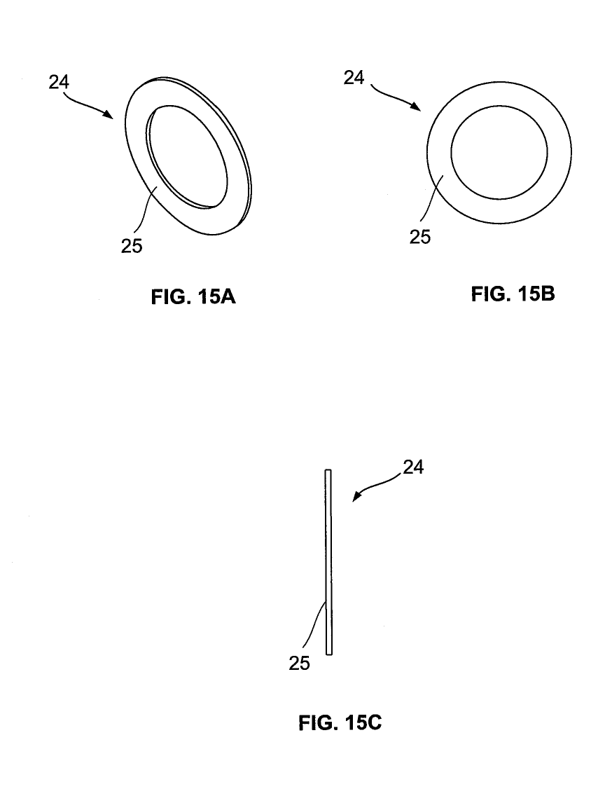

Hanger 20 may be permanently, temporarily, or releasably affixed to a wall using mount ring 24, as shown in FIGS. 3 and 15a-15c. In one embodiment, mount ring 24 may be affixed to a wall temporarily or permanently using, for example, adhesives or fasteners. To releasably affix hanger 20 to a wall, hanger 20 and mount ring 24 may together be used in combination with hook and loop fastening tape or fabric that is adhesively or otherwise secured to flange 23 of hanger 20 and mount ring 24. Thus, for example, the hook side of the fastening tape or fabric may be affixed to wall side 22 of hanger 20 (as shown in FIGS. 14c-14d) while the loop side of the fastening tape or fabric may be affixed to hanger side 25 of mount ring 24 (as shown in FIGS. 15a-15c), or vice versa. In operation, hanger 20 may be releasably secured to mount ring 24 by meshing the respective sides of the hook and loop fastener.

In another embodiment, hanger 20 may be permanently, temporarily, or releasably affixed to a wall without using mount ring 24. In this embodiment, one side of hook and loop fastening tape may be adhesively or otherwise secured to flange 23 of hanger 20 while the other side of hook and loop fastening tape may be adhesively or otherwise secured to the wall. In operation, hanger 20 may be releasably secured to the wall by meshing the respective sides of the hook and loop fastener.

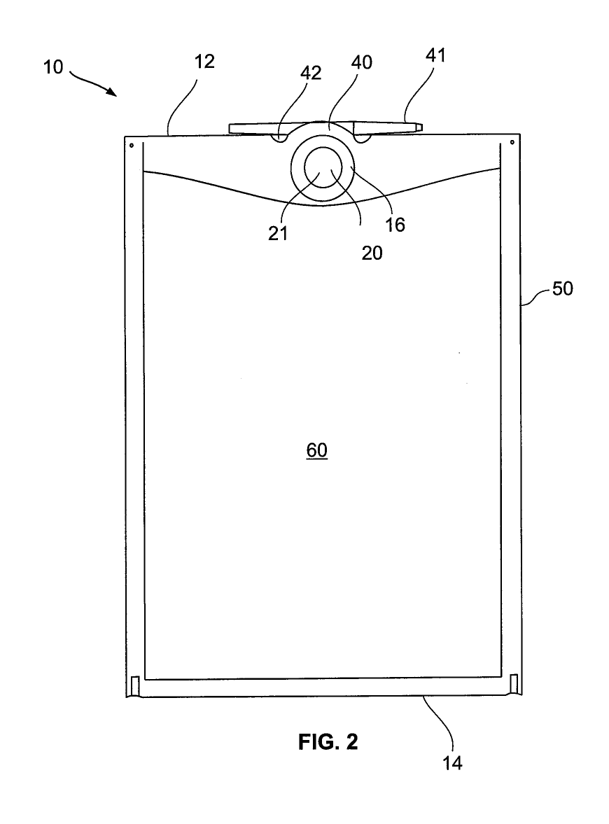

As shown in FIGS. 1-2, with hanger 20 releasably affixed to a wall, writing board 10 may be mounted onto hanger 20 by inserting hanger 20 through grommet 16, which is mounted in frame 50 of writing board 10. Grommet 16, as shown in FIGS. 1-2, 4-5, and 10a-10e may be made from a non-slip, resilient material, such as rubber or any elastomeric material, to easily grip and retain hanger 20. Moreover, grommet 16 and protrusion 21 of hanger 20 may each be sized to further assist in positively, yet releasably, securing writing board 10 on a wall.

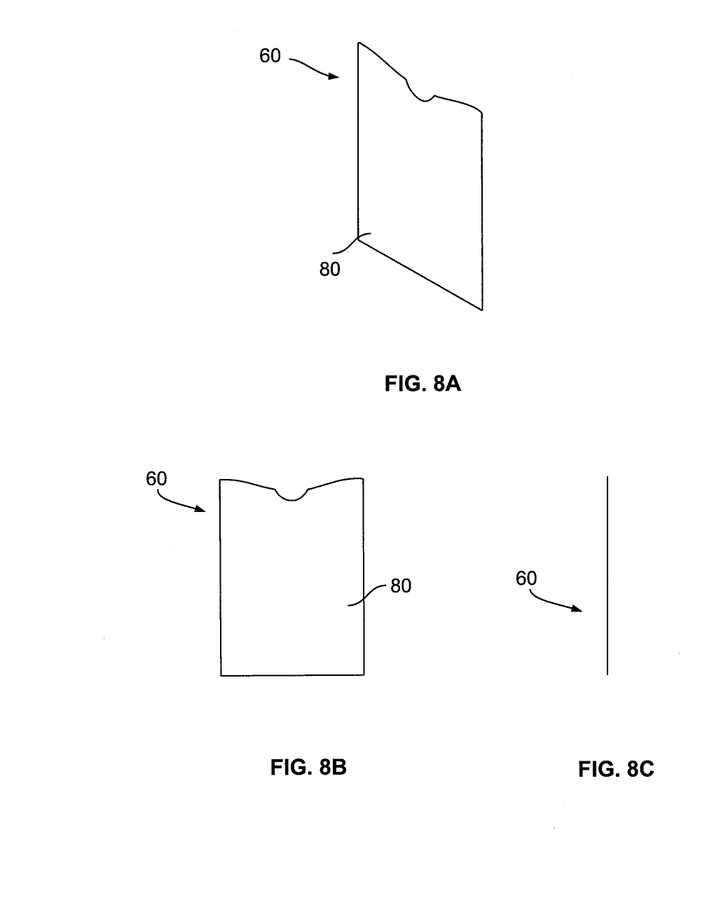

As shown in the figures, one or more dry erase panels 60 may be mounted in frame 50 to enable a user to use one or both of the front and rear sides of writing board 10. Dry erase panel 60, as best shown in FIGS. 8a-8c, may range in thickness from 0.003″ to 0.050″ thick, depending on its inherent dry erase properties.

A user using one side of writing board 10 while writing board 10 is mounted on hanger 20 may easily demount writing board 10 by decoupling writing board 10 from protrusion 21 of hanger 20, flip writing board 10 over, remount writing board 10 upon hanger 20, and use the other side of writing board 10. Similarly, a user using one side of writing board 10 while demounted from a wall may simply turn writing board 10 over and use the other side of writing board 10.

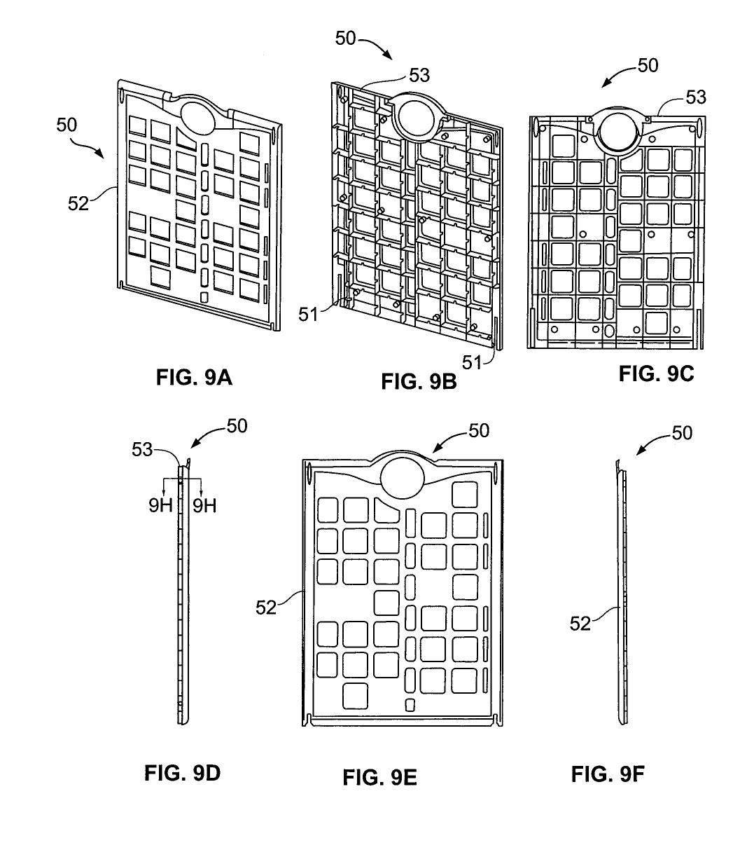

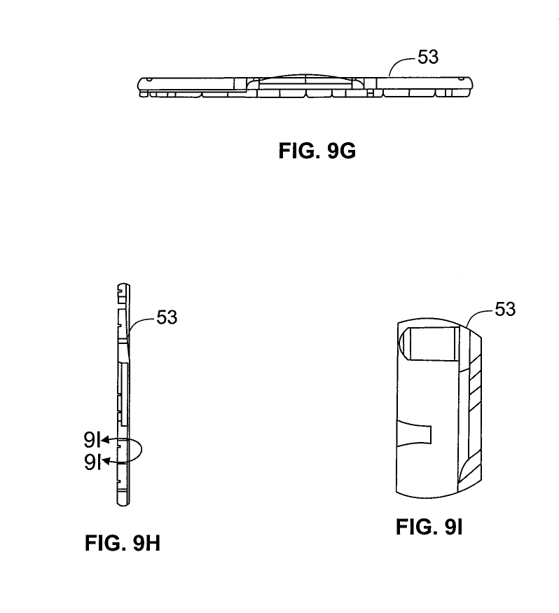

Frame 50 may be injection molded and may comprise a clamshell formed from front frame member 52 and rear frame member 53, as shown in FIGS. 7a, and 9a-9i. Frame 50 may be made from any one of a variety of materials of construction, such as plastic, including ABS, high impact polystyrene, polycarbonate, or polypropylene, for example. Alternatively, frame 50 may be made from metal, such as aluminum. Although shown in FIGS. 7a and 9a-9i as having an internal grid-like, semi-hollow structure, the internal grid-like portion of frame 50 may be replaced with a separate structure (with frame 50 mounted on its perimeter) that is formed in the shape of solid, corrugated, porous, or hollow structure or substrate, such as an I-beam structure, a honeycomb structure, a cellular structure, or any one of a number of other structural forms to provide a lightweight, strong, and inexpensive structure. This internal portion within frame 50 may provide a single structure in which both the front and rear sides may have dry erase properties. If this internal portion does not have dry erase properties, then film 80 (as described below) or other dry erase treatment or coating may be applied to one or both of the front and rear sides of this internal portion to give the internal portion dry erase properties. In this way, a single inner core could replace each of dry erase panels 60, yet still provide writing board 10 with dry erase properties on both of its sides.

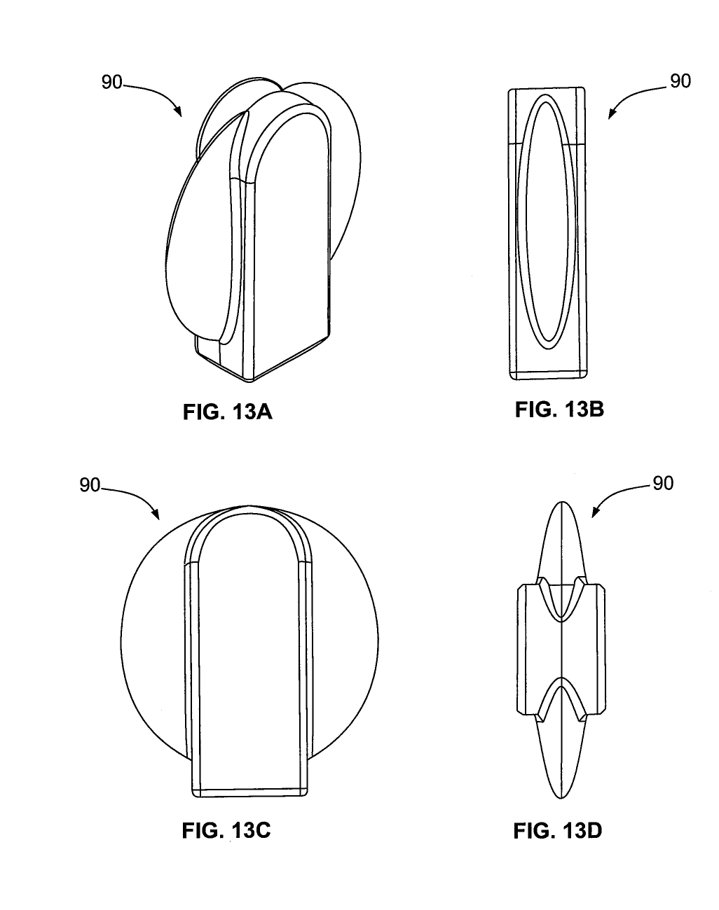

Frame 50 may be designed to support and securely retain one or more dry erase panels 60, grommet 16, and one or more nubs 90 (as shown in FIGS. 7a and 13a-13d). Front frame member 52 and rear frame member 53, as shown in FIG. 7a, may be snapped or clipped together to form a stable support for one or more dry erase panels 60 and to encase and secure grommet 16 and one or more nubs 90 within respective receptacles formed in frame 50.

Dry erase panel 60 may be formed from a plastic, such as ABS, high impact polystyrene, or polycarbonate, or may be formed from other common materials of construction, such as corrugated paper or foam core. Dry erase panel 60 may be formed with a solid, corrugated, porous, or hollow structure, such as an I-beam structure, a honeycomb structure, a cellular structure, or any one of a number of other structural forms to provide a lightweight, strong, and inexpensive structure.

If dry erase panel 60 does not itself have dry erase properties, dry erase panel 60 may be configured to include film 80, as shown on FIG. 8a. Film 80 may comprise any biaxially-oriented polyester film, UV cured polyurethane, polypropylene, or any other product, surface treatment, or coating that may provide dry erase panel 60 with dry erase properties. Dry erase panel 60, film 80, or such other products, surface treatment, or coating may have magnetic properties or non-magnetic properties. Film 80 may act as a carrier for the application of dry erase treatments or coatings if film 80 itself does not have dry erase properties. Depending on the chosen material of film 80 or the subsequent treatment or coating that may be applied to film 80, if any, the thickness of film 80 may range from approximately 0.0005″ thick to approximately 0.050″ thick. Film 80 may be laminated, deposited, or adhered to dry erase panel 60 using conventional techniques known to one of skill in the art.

As shown in Figs. FIGS. 7a and 13a-13d, writing board 10 may include one or more nubs 90 to help prevent movement, rocking or rattling of writing board 10 against a wall when writing board 10 is mounted on a wall. Nubs 90 may be mounted in frame 50 so as to protrude rearwardly towards the wall so as to rest against the wall to minimize any movement, rocking or rattling of writing board 10 during use. Nubs 90 may also be configured to protrude forwardly from frame 50 in like manner, and may simultaneously protrude forwardly and rearwardly from frame 50 to provide the user versatility of using either side of writing board 10 while minimizing any movement, rocking and rattling of writing board 10 during use of either side of writing board 10. Nubs 90 may also function to resist any unwanted or unintended rotational motion that may occur between writing board 10 and the wall during use.

Alternatively, if writing board 10 is used on a table, for example, nubs 90 may serve to stabilize writing board 10 to minimize any movement, rocking or rattling against the table and also to resist any unwanted sliding of writing board 10 relative to the table during use. Nubs 90 may be formed from rubber or any other elastomeric material suitable for these functions.

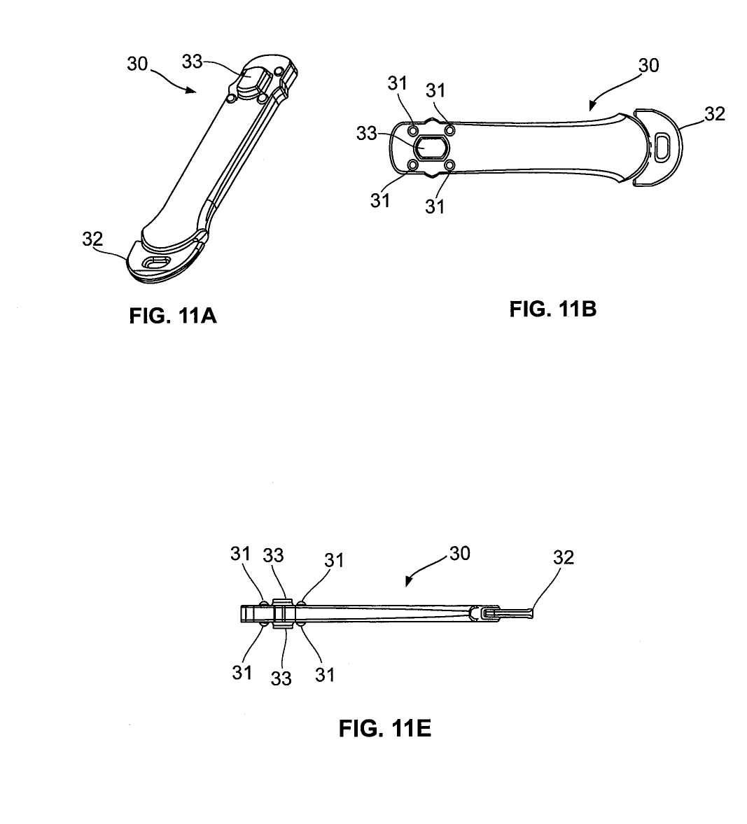

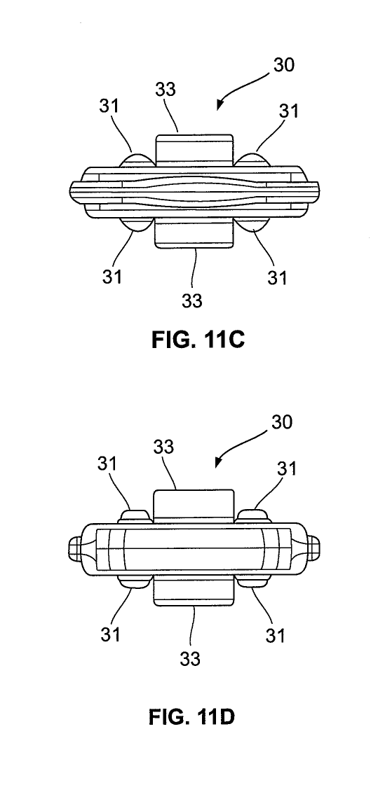

As described above, writing board 10 may include legs 30 for ergonomically angling writing board 10 for use. As shown in FIGS. 11a-11e, legs 30 may include one or more keepers 31 usable for releasably holding each of legs 30 in any one of a number of predetermined positions and/or angles relative to the plane of writing board 10, or to releasably secure legs 30 within receptacles 51 of writing board 10. Guides 33 are retained by receptacles 51 of frame 50 and are designed to permit legs 30 to slide within receptacles 51. Legs 30 may be made from a plastic, such as ABS, high impact polystyrene, or polycarbonate, or a metal, such as aluminum, for example.

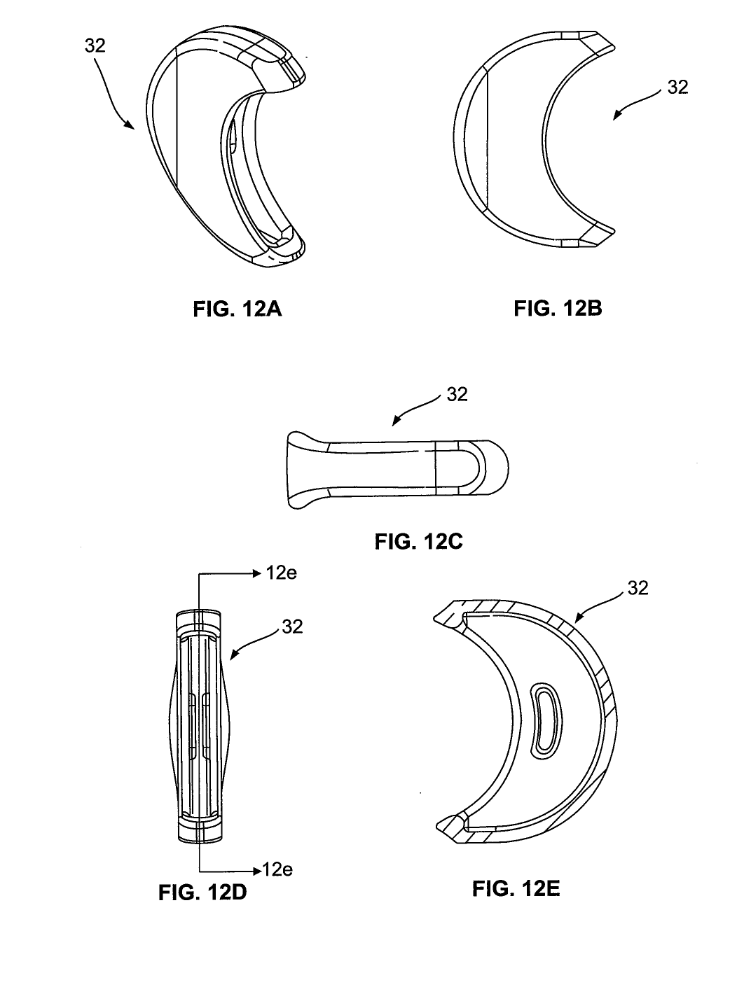

To assist in preventing relative movement (i.e., sliding and/or rotational motion) between legs 30 and the wall or tabletop when legs 30 have been articulated in one of the chosen angles, each of legs 30 may also include end cap 32, as shown in FIGS. 3, 6b-6d, 11a-11c, 11e, and 12a-12e. End cap 32 may be formed from rubber or any other elastomeric material suitable for this purpose.

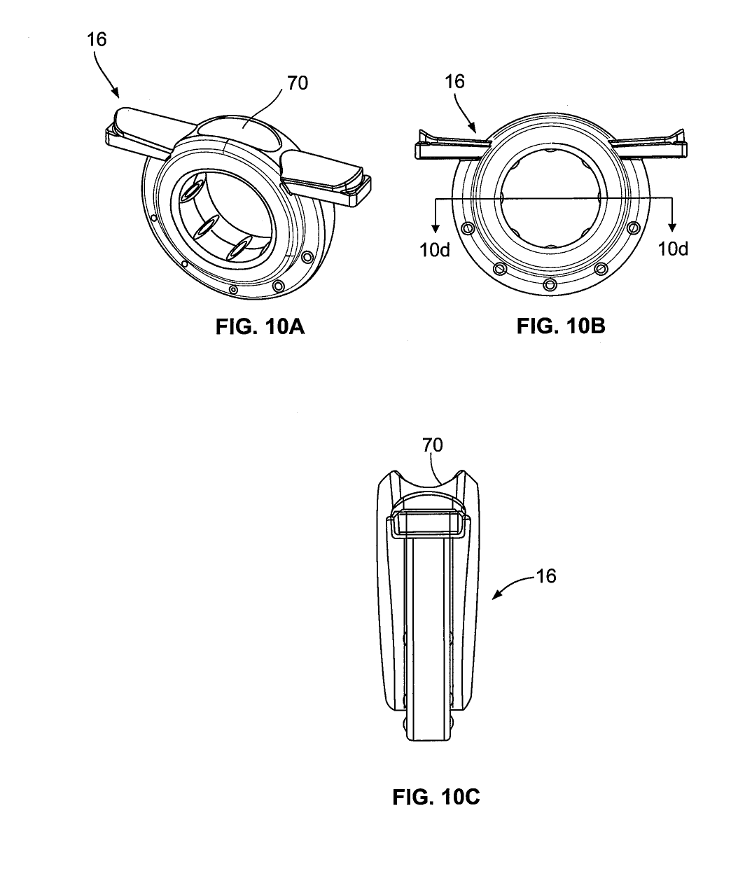

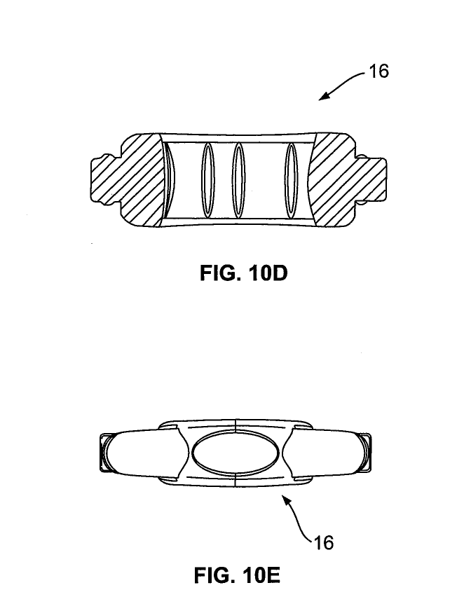

As shown in FIGS. 1-4 and 7a-7c, writing board 10 may include writing utensil holder 40 for releasably securing writing utensil 41. When grommet 16 is installed in frame 50, top surface 70 of grommet 16, as shown in FIGS. 10a and 10c, may form grip 42 to aid in gripping and/or securing writing utensil 41 in writing utensil holder 40.

While specific embodiments of the invention have been described in detail, it will be appreciated by those skilled in the art that various modifications and alternatives to those details could be developed in light of the overall teachings of the disclosure. Accordingly, the particular method disclosed is meant to be illustrative only and not limiting as to the scope of the invention which is to be given the full breadth of the appended claims and any equivalents thereof.

What is claimed is:

1. A writing board, comprising:
a frame; and
a front panel and a rear panel mounted in the frame,
wherein the front panel comprises a first writing surface and the rear panel comprises a second writing surface opposite the first writing surface,
wherein the first writing surface and the second writing surface are each adapted to erasably receive writing thereon,
wherein the writing board is reorientable to receive writing on the first writing surface and the second writing surface.

2. The writing board of claim 1, wherein at least one of the front panel and the rear panel comprise a magnetic property.

3. The writing board of claim 1, further including a wall mount for hanging the writing board on a wall, comprising
a hanger releasably affixed to the wall, wherein the hanger comprises a protrusion extending away from the wall; and
a receiver mounted in the frame and forming a passage through the writing board for receiving the protrusion of the hanger.

4. The writing board of claim 3, wherein a writing utensil holder is integrally formed with the frame for releasably securing a writing utensil to the writing board.

5. The writing board of claim 4, wherein the receiver forms a bottom surface of the writing utensil holder and includes a non-slip surface for mating with the writing utensil and for mating with the protrusion.

6. The writing board of claim 1, wherein the frame comprises a front frame member connected to a rear frame member, wherein the front panel is mounted to the front frame member and the rear panel is mounted to the rear frame member.

7. The writing board of claim 1, further including a plurality of nubs mounted in the frame and protruding therefrom to minimize movement, rocking or rattling of the writing board during use.

8. The writing board of claim 1, further including a plurality of legs extendable from and retractable into the frame, the plurality of legs rotatable to tilt the writing board to at least one predetermined angle.

9. The writing board of claim 8, wherein each of the plurality of legs are rotatable over a range exceeding 180° to provide an ergonomic writing angle for a user of the writing board.

10. The writing board of claim 8, wherein each of the plurality of legs includes at least one keeper for releasably holding the legs in any one of a number of predetermined angles or to releasably secure the legs within the frame.

11. The writing board of claim 8, wherein each of the plurality of legs includes an end cap to minimize movement, rocking or rattling of the writing board during use.

12. A writing board, comprising:
at least one writing panel mounted to a frame, wherein the writing panel is adapted to erasably receive writing thereon;
a writing utensil holder integrally formed with the frame for releasably securing a writing utensil to the writing board; and
a plurality of legs extendable from and retractable into the frame, the plurality of legs positionable to tilt the writing board to at least one predetermined angle.

13. The writing board of claim 12, wherein the writing board is reorientable to receive writing on a first and a second side of the at least one writing panel.

14. The writing board of claim 13, further including a film adapted to erasably receive writing thereon, the film being affixed to at least one of the first and second sides of the at least one writing panel.

15. The writing board of claim 12, wherein the at least one writing panel comprises a magnetic property.

16. The writing board of claim 12, further including a wall mount for hanging the writing board on a wall, comprising
a hanger releasably affixed to the wall, wherein the hanger comprises a protrusion extending away from the wall; and
a receiver mounted in the frame and forming a passage through the writing board for receiving the protrusion of the hanger.

17. The writing board of claim 16, wherein the hanger is releasably fastened to the wall using a hook and loop fastener.

18. The writing board of claim 12, further including a core comprising one of a solid, corrugated, porous, or hollow structure.

19. A writing board, comprising:
at least one writing panel mounted to a frame, wherein the writing panel is adapted to erasably receive writing thereon; and
a receiver mounted in the frame and forming a passage through the writing board for receiving a hanger,
wherein the writing board is reorientable to receive writing on a first and a second side of the at least one writing panel.

20. The writing board of claim 19, wherein the frame includes a writing utensil holder integrally formed with the frame for releasably securing a writing utensil to the writing board.

21. The writing board of claim 19, wherein the frame includes a plurality of receptacles for housing a plurality of legs, wherein the plurality of legs are extendable from and retractable into the plurality of receptacles, the plurality of legs being positionable to tilt the writing board to at least one predetermined angle.

22. The writing board of claim 19, further including a hanger releasably affixed to a wall, wherein the hanger comprises a protrusion having a non-slip surface for releasable mating with the receiver.

23. The writing board of claim 19, wherein the at least one writing panel comprises a magnetic property.
